(19) United States
(12) Patent Application Publication
(10) Pub. No.: US 2017/0107075 A1
(43) Pub. Date: Apr. 20, 2017

(54) STRING COILING UNIT FOR A WINDOW SHADE WITHOUT A PULL CORD

(71) Applicants: SHIH-MIN HUNG, (US); MING-HSUAN HSU, CHANGHUA COUNTY 506 (TW)

(72) Inventor: SHIH-MIN HUNG, CHANGHUA COUNTY 514 (TW)

(21) Appl. No.: 14/885,520

(22) Filed: Oct. 16, 2015

(51) Int. Cl. B65H 75/44; E06B 9/32

(52) U.S. Cl. CPC B65H 75/4405; E06B 9/32; E06B 2009/3222

(57) ABSTRACT

A string coiling unit is mounted in a top frame of a window shade without a pull cord. The string coiling unit includes a casing receiving a vortex spring device and two reels operably connected to the vortex spring device. Two axles are mounted in the casing. A guiding wheel is mounted around each axle, is shorter than the axle, and includes an annular first groove for receiving one of the driving strings. Each driving strings is wound around a deflecting portion of one of two string guiding mechanisms before extending through the shade unit in the vertical direction, such that drag and hindrance to portions of the two driving strings extending in the horizontal direction caused by the weight of the shade unit are interrupted to reduce deviation of the two driving strings wound around the two reels.

### BACKGROUND OF THE INVENTION

The present invention relates to a coiling structure for a window shade and, more particularly, to a string coiling unit for a window shade without a pull cord.

In addition to shield from the sunlight and to provide privacy, window shades provide room decoration and show the user's taste. A typical window shade includes a shade unit that can be moved upward or downward by operating a pull cord. To avoid a playful child from being strangled by the exposed length of the pull cord, window shades without a pull cord for manual operation are provided and include a driving string for moving the slats. Although the main structures of the window shades without a pull cord are different, the common mechanism for folding and unfolding the shade unit generally includes a casing receiving a reel connected to a vortex spring unit. A driving string is wound around the reel. Namely, an end of the driving string is connected to the reel. The other end of the driving string is connected to the shade unit. A balance exists between the weight of the shade unit and the vortex spring unit and is manually destroyed when it is desired to fold or unfold the shade unit. In actual operation, the driving string cannot be smoothly coiled and released due to deflection of the driving string and uncertainty of force application and elasticity while the window shade and the vortex spring unit provide the balance. Thus, the shade unit cannot be smoothly folded and unfolded.

Furthermore, overlapping of the driving string occurs due to deflection of the driving string, such that the shade unit sways and becomes skewed during folding and unfolding, adversely affecting smoothness while folding and unfolding the window shade. As a result, undesired gaps exist in local areas of the window shade after the window shade is positioned, failing to provide a smooth appearance.

### BRIEF SUMMARY OF THE INVENTION

A string coiling unit according to the present invention is adapted to be mounted in a top frame of a window shade without a pull cord and is adapted for elastically coiling first and second driving strings for folding and unfolding a shade unit of the window shade. The string coiling unit includes a casing having a top wall and a bottom wall. A vortex spring device is mounted in the casing. First and second reels are mounted in the casing and are operably connected to the vortex spring device. A first axle is mounted between the top wall and the bottom wall. A first guiding wheel is mounted around the first axle and has a length smaller than a length of the first axle. The first guiding wheel includes an annular first groove. The first driving string is received in the annular first groove. A second axle is mounted between the top wall and the bottom wall. A second guiding wheel is mounted around the second axle and has a length smaller than a length smaller than a length of the second axle. The second guiding wheel includes an annular second groove. The second driving string is received in the annular second groove. First and second string guiding mechanisms respectively guide the first and second driving strings from a horizontal direction to a vertical direction. Each of the first and second string guiding mechanisms includes a deflecting portion. Each of the first and second driving strings is wound around the deflecting portion of one of the first and second string guiding mechanisms before extending through the shade unit in the vertical direction, such that drag and hindrance to portions of the first and second driving strings extending in the horizontal direction caused by the weight of the shade unit are interrupted to reduce deviation of the first and second driving strings wound around the first and second reels.

Each of the first and second string guiding mechanisms can include a plurality of guiding rollers for guiding one of the first and second driving strings.

The first reel can include a first gear on a top portion thereof. The vortex spring device can include a driving wheel having a top portion with a gear. The gear on the top portion of the driving wheel meshes with the first gear of the first reel for joint movement with the first reel.

The first reel can further include a second gear on a bottom portion thereof. The driving wheel can further include a bottom portion with a gear. The gear on the bottom portion of the driving wheel meshes with the second gear of the first reel for joint movement with the first reel.

The second reel can include two gears respectively on top and bottom portions thereof. The two gears of the second reel respectively mesh with the first and second gears of the first reel.

Since the string coiling unit according to the present invention includes first and second guiding wheel having lengths respectively smaller than the lengths of the first and second axles, each of the first and second guiding wheels is provided with a space to move freely along a longitudinal axis of one of the first and second axles. When the first and second driving strings are moving around the first and second guiding wheels while the shade unit and the vortex spring device are providing a counterbalance effect, although slight friction occurs during movement of the first and second driving strings and results in hindrance, the hindrance can be overcome by the inertia of the elastic returning force of the vortex spring device. Furthermore, the first and second guiding wheels has certain spatial freedom to move freely along the longitudinal axis of the second axle, such that the first and second guiding wheels can move slightly under the action of the larger elastic returning force of the vortex spring device, obtaining a dynamic balance under the conditions of the hindrance and the spatial freedom. Thus, each of the first and second driving strings presents a neat appearance on the corresponding one of the first and second reels.

Furthermore, each of the first and second string guiding mechanisms includes a deflecting portion. Each of the first and second driving strings is wound around one of the deflecting portions before extending through the shade unit in the vertical direction. By winding the first and second driving strings around the deflecting portions, the drag and hindrance to portions of the first and second driving strings extending in the horizontal direction caused by the weight of the shade unit are interrupted to reduce deviation of the first and second driving strings wound around the first and second reels.

The present invention will become clearer in light of the following detailed description of illustrative embodiments of this invention described in connection with the drawings.

### DESCRIPTION OF THE DRAWINGS

FIG. 1 is a perspective view of a window shade using a string coiling unit according to the present invention.

FIG. 2 is a perspective view of the string coiling unit according to the present invention.

FIG. 3 is another perspective view of the string coiling unit of FIG. 2.

FIG. 4 is an exploded view of a portion of the string coiling unit of the window shade according to the present invention.

FIG. 5 is a perspective view of a second string guiding mechanism of the window shade according to the present invention.

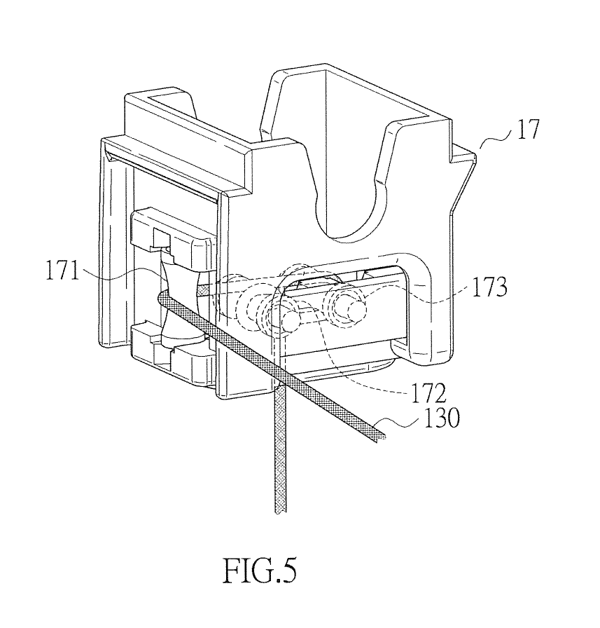

FIG. 6 is a schematic top view illustrating operation of guiding wheels of the window shade according to the present invention.

### DETAILED DESCRIPTION OF THE INVENTION

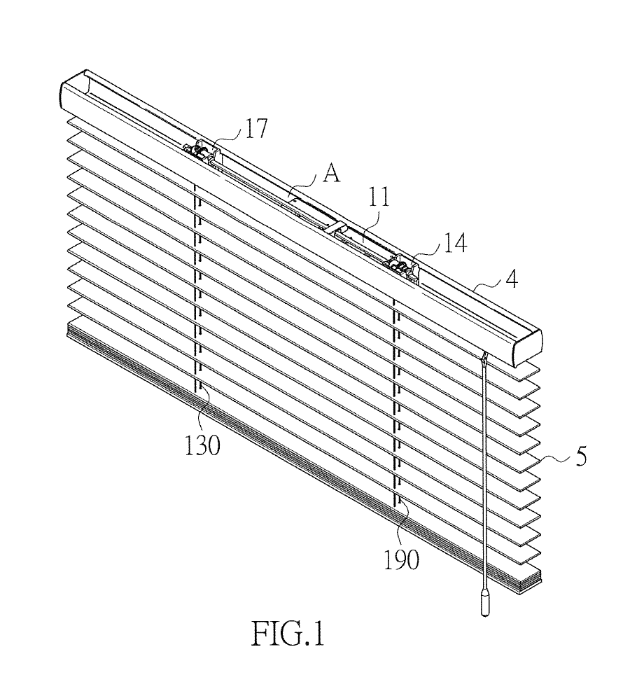

With reference to FIG. 1, a string coiling unit A for a window shade without a pull cord according to the present invention is adapted to be mounted in a top frame 4 of a window shade without a pull cord and is adapted for elastically coiling first and second driving strings 190 and 130 for folding and unfolding a shade unit 5 of the window shade.

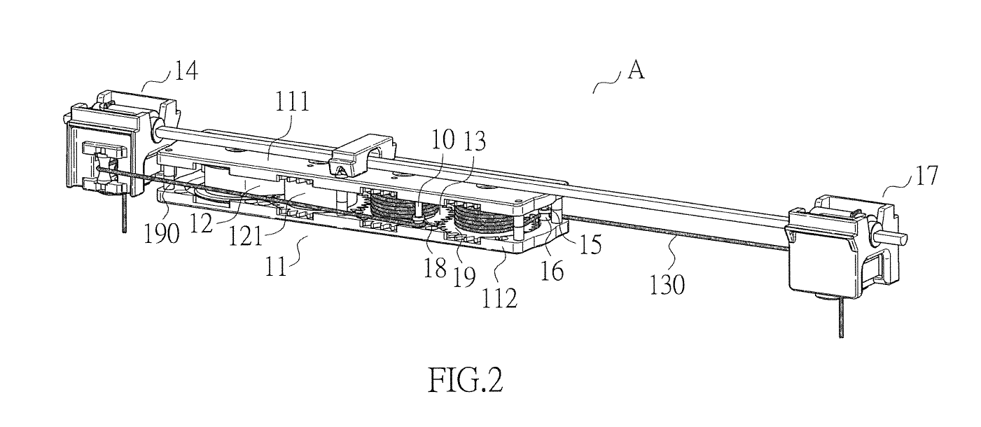

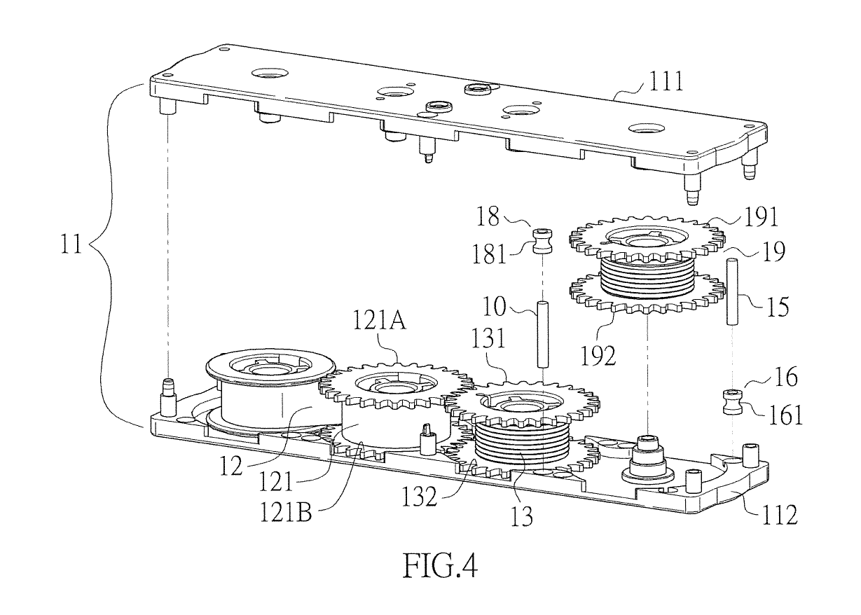

With reference to FIGS. 2-4, the string coiling unit A includes a casing 11 having a top wall 111 and a bottom wall 112. A vortex spring device 12 is mounted in the casing 11. First and second reels 19 and 13 are mounted in the casing 11 and are operably connected to the vortex spring device 12. As shown in FIG. 2, the first driving string 190 is wound around the first reel 13. The first reel 13 includes a first gear 131 on a top portion thereof. The vortex spring device 12 includes a driving wheel 121 having a top portion with a gear 121A. The gear 121A on the top portion of the driving wheel 121 meshes with the first gear 131 of the first reel 13 for joint movement with the first reel 131. To provide more accurate transmission, the first reel 13 further includes a second gear 132 on a bottom portion thereof, and the driving wheel 121 further includes a bottom portion with a gear 121B. The gear 121B on the bottom portion of the driving wheel 121 meshes with the second gear 132 of the first reel 13 for joint movement with the first reel 13.

A first axle 10 is mounted between the top wall 111 and the bottom wall 112. A first guiding wheel 18 is mounted around the first axle 10 and has a length smaller than a length of the first axle 10. Furthermore, the first guiding wheel 18 includes an annular first groove 181 for receiving the first driving string 190.

The second driving string 130 is mounted around the second reel 19. The second reel 19 includes two gears 191, 192 respectively on top and bottom portions thereof. The two gears 191 and 192 of the second reel 19 respectively mesh with the first and second gears 131 and 132 of the first reel 131.

A second axle 15 is mounted between the top wall 111 and the bottom wall 112. A second guiding wheel 16 is mounted around the second axle 15 and has a length smaller than a length smaller than a length of the second axle 15. The second guiding wheel 16 includes an annular second groove 161 for receiving the second driving string 130.

First and second string guiding mechanisms 14 and 17 are provided to respectively guide the first and second driving strings 190, 130 from a horizontal direction to a vertical direction before extending through the shade unit 5. The first and second string guiding mechanisms 14 and 17 are identical in this embodiment. Thus, only the second string guiding mechanism 17 is described. The second string guiding mechanism 17 includes a plurality of guiding rollers 172 and 173 for smoothly guiding the second driving string 130. The second string guiding mechanism 17 further includes a deflecting portion 171. The second driving string 130 is wound around the deflecting portion 171 before extending through the shade unit 5 in the vertical direction. By winding the second driving string 130 around the deflecting portion 171, the drag and hindrance to a portion of the second driving string 130 extending in the horizontal direction caused by the weight of the shade unit 5 are interrupted to reduce deviation of the second driving string 130 wound around the second reel 19.

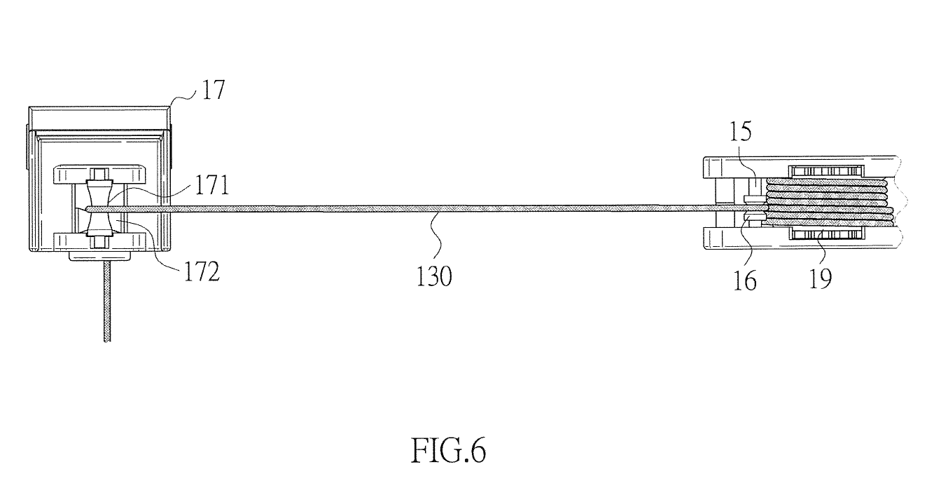

The string coiling unit A according to the present invention includes two sets of guiding wheels having substantially identical structure. The structure shown in FIG. 6 is used to describe the operation and the effect. Since the string coiling unit A according to the present invention includes the second guiding wheel 16 having a length smaller than the length of the second axle 15, the second guiding wheel 16 is provided with a space to move freely along a longitudinal axis of the second axle 15.

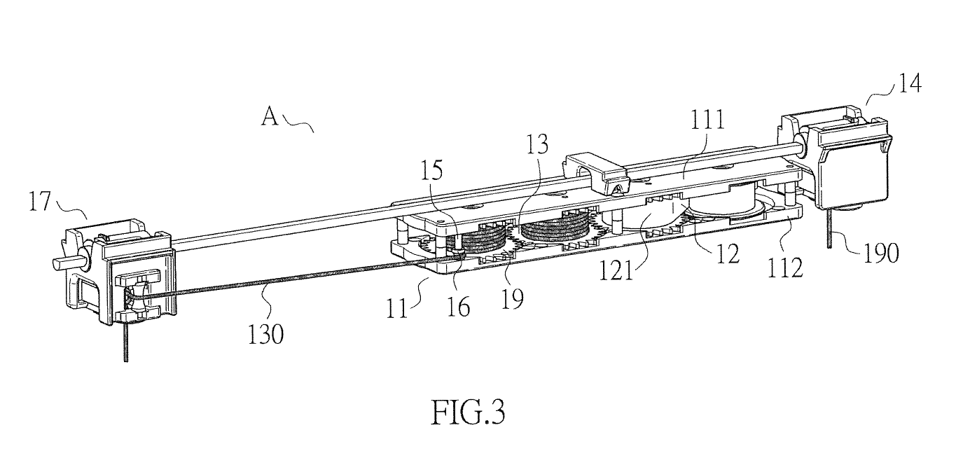

When the second driving string 130 is moving around the second guiding wheel 16 while the shade unit 5 (FIG. 1) and the vortex spring device 12 (FIG. 3) are providing a counterbalance effect, although slight friction occurs during movement of the second driving string 130 and results in hindrance, the hindrance can be overcome by the inertia of the elastic returning force of the vortex spring device 12 (FIG. 3). Furthermore, the second guiding wheel 16 has certain spatial freedom to move freely along the longitudinal axis of the second axle 15, such that the second guiding wheel 16 can move slightly under the action of the larger elastic returning force of the vortex spring device 12 (FIG. 3), obtaining a dynamic balance under the conditions of the hindrance and the spatial freedom. Thus, the second driving string 130 presents a neat appearance on the corresponding second reel 19.

For example, when the second driving string 130 is being wound around the second reel 19, unevenness or deviation of the force application of the second driving string 130 could result in a string overlapping situation. Nevertheless, the elastic returning force of the vortex spring device 12 (FIG. 3) is normally stable to permit free movement of the second guiding wheel 16 along the longitudinal axis of the second axle 15, avoiding stiff operation (the “hindrance” mentioned above) of the second guiding wheel 16. Furthermore, the freedom of the second guiding wheel 16 does not adversely affect smooth winding of the second driving string 130, such that the second driving string 130 can be wound around the second reel 19 in order and in a neatly coiled state.

Furthermore, each of the first and second driving strings 190 and 130 can be wound around the deflecting portion 171 of one of the first and second string guiding mechanisms 14 and 17 before extending through the shade unit 5 (FIG. 1), such that the drag and hindrance to the horizontally extending portions of the first and second driving strings 190 and 130 caused by the weight of the shade unit 5 are interrupted to reduce deviation of portions of the first and second driving strings 190 and 130 wound around the first and second reels 13 and 19. Thus, the coiling and releasing states of the first and second driving strings 190 and 130 can be decided by the main power source (namely, the elastic returning force of the vortex spring device 12) to avoid or reduce the influence of the drag and hindrance to the first and second driving strings 190 and 130 caused by the weight of the shade unit 5. As a result, the string overlapping situation of the first and second driving strings 190 and 130 can be avoided to provide an ordered, neat coiling/releasing effect for the first and second driving strings 190 and 130.

Although specific embodiments have been illustrated and described, numerous modifications and variations are still possible without departing from the scope of the invention. The scope of the invention is limited by the accompanying claims.

What is claimed is:

1. A string coiling unit for a window shade without a pull cord, with the string coiling unit adapted to be mounted in a top frame of a window shade without a pull cord and adapted for elastically coiling first and second driving strings for folding and unfolding a shade unit of the window shade, with the string coiling unit comprising:
a casing including a top wall and a bottom wall;
a vortex spring device mounted in the casing;
first and second reels mounted in the casing and operably connected to the vortex spring device;
a first axle mounted between the top wall and the bottom wall;
a first guiding wheel mounted around the first axle and having a length smaller than a length of the first axle, with the first guiding wheel including an annular first groove, and with the first driving string received in the annular first groove;
a second axle mounted between the top wall and the bottom wall;
a second guiding wheel mounted around the second axle and having a length smaller than a length smaller than a length of the second axle, with the second guiding wheel including an annular second groove, and with the second driving string received in the annular second groove; and
first and second string guiding mechanisms respectively guiding the first and second driving strings from a horizontal direction to a vertical direction, with each of the first and second string guiding mechanisms including a deflecting portion, with each of the first and second driving strings wound around the deflecting portion of one of the first and second string guiding mechanisms before extending through the shade unit in the vertical direction, such that drag and hindrance to portions of the first and second driving strings extending in the horizontal direction caused by a weight of the shade unit are interrupted to reduce deviation of the first and second driving strings wound around the first and second reels.

2. The string coiling unit for a window shade without a pull cord as claimed in claim 1, wherein each of the first and second string guiding mechanisms includes a plurality of guiding rollers for guiding one of the first and second driving strings.

3. The string coiling unit for a window shade without a pull cord as claimed in claim 1, with the first reel including a first gear on a top portion thereof, with the vortex spring device including a driving wheel having atop portion with a gear, and with the gear on the top portion of the driving wheel meshed with the first gear of the first reel for joint movement with the first reel.

4. The string coiling unit for a window shade without a pull cord as claimed in claim 3, with the first reel further including a second gear on a bottom portion thereof, with the driving wheel further including a bottom portion with a gear, and with the gear on the bottom portion of the driving wheel meshed with the second gear of the first reel for joint movement with the first reel.

5. The string coiling unit for a window shade without a pull cord as claimed in claim 4, with the second reel includes two gears respectively on top and bottom portions thereof, and with the two gears of the second reel respectively meshed with the first and second gears of the first reel.
